(19) United States
(12) Patent Application Publication
(10) Pub. No.: US 2004/0043165 A1
(43) Pub. Date: Mar. 4, 2004

(54) Lidding components for containers

(76) Inventors: Keith Eugene Van Hulle, Clemmons, NC (US); Scott Stephen Super, Winston-Salem, NC (US); Dennis Lee Carespodi, Winston-Salem, NC (US)

Correspondence Address: Charles W. Calkins, Kilpatrick Stockton LLP, 1001 West Fourth St., Winston-Salem, NC, 27101, US

(21) Appl. No.: 10/228,773

(22) Filed: Aug. 27, 2002

(51) Int. Cl. B32B 1/02

(52) U.S. Cl. 428/34.2; 428/35.7

(57) ABSTRACT

A container is sealed using a lidding material and induction sealing techniques. The container possesses a main body portion (e.g., a bottle or jar) housing contents of the container (e.g., aspirin or antacid) and has an opening for dispensing those contents. A cap portion covers the opening of the main body portion. A laminated lidding material is positioned over the opening of the main body portion in such a manner so as to provide for covering of that opening. The lidding material also is positioned so as to fit within the inside of the cap portion. The cap and main body portions are mechanically sealed, and the resulting container assembly is subjected to induction sealing conditions so as to cause sealant of the lidding material to form a seal between the main body portion and the lidding material. The lidding material is a laminate comprising thermoplastic film, metallic foil film, a thermoplastic gasket, a breakaway adhesive layer, and a sealant film.

### BACKGROUND OF THE INVENTION

The present invention relates to containers, and in particular, to containers having removable cap portions and possessing lidding features.

Containers, such as bottles and jars, are used for the packaging, distribution and storage of a wide variety of products. The products contained in those containers have included numerous materials that have liquid or solid forms. For example, those products have had the forms of liquid solutions, suspensions, slurries, emulsions, powders, granules, tablets, gelcaps, caplets, capsules, liquid-gels, and the like. Those products have included foods (e.g., instant coffee granules, non-dairy coffee creamer powder, milk, and drink mixes); vitamins (e.g., multi-vitamin formulations); pharmaceuticals, including prescription and over-the-counter (OTC) drugs (e.g., aspirin, acetaminophen, ibuprofen, other pain relievers, vicodin, antacids, cold and sinus medications, cold and flu medications, and certain disease specific drugs); and dietary supplements (e.g., ginger root tablets, ginsing tablets, and calcium supplements).

Popular containers are designed so as to have main body portions into which the contents of the container are deposited, and mechanical sealing mechanisms using commonly referred to as “caps.” Those containers further possess lidding features, and various lidding features have been developed. In addition, certain containers incorporate lidding materials to provide tamper evident features to sealed containers. The caps and lidding features allow the resulting container to remain sealed, to be opened at the desired time, and preferably, to allow the container to be re-sealed and re-opened numerous times. For example, the cap and lidding arrangement can have a registered “pop-off” type mechanism using friction fit, or be designed to have a “screw-on” type mechanism using co-aligning threads that are formed into the inside face of the bottom of the lidding and the outside face of the top of the main body of the container. Certain containers are designed so that the cap and main body portions have child resistant features.

Certain containers that have proven to be commercially popular among product manufacturers and consumers are of the thermoplastic bottle-type containers. The main body portions of those types of containers are commercially available from manufacturers such as Alpha Plastics, Comar Inc., Dana Plastic Container Corp., Drug Plastics & Glass Company, Inc., Owens-Brockway, Owens-Illinois, Rexam Closures & Containers, and Wheaton Plastics. Other components of those containers, such as certain cap and closure portions of the of those containers, are commercially available from manufacturers such as Portola, Top Seal Corp., Poly-Tainer, Dana Plastic Container Corp., and Pechiney.

Particularly popular containers, such as bottles and jars, have had main body portions manufactured from materials such as glass, high density polyethylene (HDPE), low density polyethylene (LDPE), polyester terephlalate (PET), polystyrene (PS), polyvinylchloride (PVC), polyester copolymers (PETG), or polypropylene (PP). Those main body portions have had cap or closure portions that have been manufactured from materials such as LDPE, HDPE and PP. In addition, it has been common practice to position a lidding mechanism within the inside top region of the cap. Exemplary bottle-type containers are used to package OTC pharmaceutical-type products such as St. Joseph from McNeil-PPC, Inc.; Tylenol from McNeil-PPC, Inc.; Motrin IB from McNeil-PPC, Inc.; Mylanta from Johnson & Johnson—Merck Consumer Pharmaceuticals Co.; Magnesia from Eckerd Drug Co.; Centrum from Whitehall-Robins Healthcare; Advil from Wyeth; and Anacin from Wyeth.

Typically, pharmaceutical-type products that are packaged for distribution, particularly for OTC drug distribution, are dispensed into thermoformed or injection molded HDPE containers (e.g., white bottles). For example, a predetermined number of tablets or capsules (i.e., counts of 50, 75, 100 or 150) or a predetermined volume of liquefied drug suspension (i.e., 10, 25, or 50 ml) is dispensed into the main body portion of the container. Following the filling process, a bottle label and the cap portion are attached to the main body portion. The bottle label typically is a paper material containing product indicia and other required product and labeling information, and that material usually is fastened to the main body portion using a suitable pressure sensitive adhesive. Typically, the cap portion is a thermoformed plastic material. Lidding material manufactured from two laminated components that have been combined usually are inserted into the inside top region of the cap prior to application to the main body portion. As such, typical lidding materials useful in such applications are referred to as “two-component laminate” type lidding materials.

The first component of a traditional two-component laminate type lidding material is composed of a thermoplastic polymer film, such as a PET film, that is attached adhesively to a relatively thick layer of paperboard material. Alternatively, that first component simply is a single relatively thick layer of paperboard material. The second component of a traditional two-component laminate type lidding material is a laminated material composed of a layer of thermoplastic (e.g., PET), a layer of adhesive, a layer of foamed polyolefin having a thickness of about 0.004 to about 0.010 inch (i.e., about 4 to about 10 mils), a layer of adhesive, a layer of aluminum foil having a thickness of about 0.7 to about 2 mils, a layer of adhesive, and a layer of sealant film having a thickness of about 0.4 to about 3 mils. One type of sealant film is composed primarily of LDPE. Generally, the two components are laminated together using a process that applies a hot wax coating to the paperboard material of the first component followed by a hot lamination to the PET side of the second component, thereby forming a lidding material. The lidding material then is die cut to the desired size and shape, and inserted into the cap portion. Representative components of lidding materials are commercially available from Sancap, Alcoa, and as Tacseal from Owens-Brockway.

The main body portion and the cap portion possessing the lidding material are combined and sealed. See, for example, Zito, Pharmaceutical & Medical Packaging News, p. 24 (April, 2002). The main body portion, after being appropriately cleaned, is filled with the desired amount of product. Then, the cap portion is placed on the filled main body portion, and mechanically closed. The filled, closed container then is passed through an induction sealing region. There, electromagnetic radiation (i.e., a radio frequency signal) is directed at the region of the container where the cap portion is in contact with the main body portion. As a result, the foil layer of the second component of the lidding material is radiantly heated, and the resulting heat possessed by that foil is transferred to the adjacent sealant material of that second component. This sealant material, now in a molten state, bonds to the top lip region of the main body portion, thereby creating a type of weld seal. In addition, heat transfer from the foil layer to the wax layer causes that wax layer to soften. As a result, that heated wax migrates into the paperboard layer of the lidding material, causing the first and second components of the lidding material to separate. The heated wax also provides a wax coating to the adjacent surface of the paperboard material. Other packaging materials then can be applied to the container, and the container is distributed to consumers.

The container is opened by the consumer by physically removing the cap portion from the body portion. When the container is opened by the consumer, the first component of the lidding material stays within the cap. That first component remains secured within the cap as a result of friction fit and/or as a result of an adhesive material (e.g., wax) that secures the top face of that first component to the inside top surface of the cap. The second component of the lidding material, because it is effectively sealed to the lip of the main body portion, stays on the main body portion and provides a tamper-evident closure for the consumer to inspect. Generally, the consumer pokes a perforation through the second component lidding material, tears off most of that material, ultimately leaving only a ring of the second component material remaining in the region around lip of the main body portion. This resulting ring provides further visual evidence of tamper resistance. The first component of the lidding material, now physically separated from the second component, stays inside the cap portion, and acts as a “gasket” when the cap portion is re-applied to the main body portion by the consumer.

It would be highly desirable to provide improvements to those types of containers used for the packaging, distribution and storage or a wide variety of products. In particular, it would be highly desirable to provide lidding features for containers that are designed so as to provide improved containers that are sealed using induction sealing techniques.

### SUMMARY OF THE INVENTION

The present invention relates to sealed containers possessing the lidding materials of the present invention. A representative container comprises a main body portion that is designed to house contents of the container, and possesses an opening for dispensing those contents from that main body portion. The container also comprises a cap or closure portion designed to mechanically seal the opening in the main body portion. The container further comprises a lidding material positioned over the top of the opening of the main body portion and within the cap portion of the container. The lidding material is designed so as to be capable of providing induction sealing of the container. Preferred lidding materials of the present invention are designed to separate in a pre-determined fashion and location upon use. As a result, a preferred lidding material comprises (i) a lower section providing tamper-evident seal to the opening of the bottle or jar, and (ii) an upper section providing a gasket-type feature for the cap portion of that bottle or jar.

The present invention, in another aspect, relates to lidding materials for containers. The lidding materials are laminates that are several layers thick. Highly preferred lidding materials are laminates that are manufactured as a single laminate, as opposed to two laminates that are combined into a single laminate in subsequent processing steps using a layer of wax. The lidding material possesses (i) a layer that remains within the cap portion of the container and behaves as a gasket; (ii) a sealant material for bonding at least a portion of the laminate to the main body portion of the container; (iii) a material for providing a source of heat to melt the sealing material during induction sealing process steps (e.g., a metallic foil layer); and (iv) a “breakaway” adhesive to provide lamination of the upper gasket portion with the lower barrier seal portion of the lidding material (at least during the manufacture of the lidding material). The lidding material also preferably can possess at least one further layer of thermoplastic polymer material, such as a layer that acts to provide further barrier properties for the sealing of the opening of the main body portion of the container. Lidding materials of the present invention can possess two metallic foil layers (i.e., in both the upper gasket and the lower lidding portions); however, typical lidding materials possess only one metallic foil layer in either of the upper gasket or lower lidding portions.

Particularly preferred lidding materials of the present invention are laminates that do not possess layers of paperboard materials and/or layers of wax (i.e., are absent of a layer of paperboard and/or wax within the laminate structure). However, in certain aspects of the present invention, certain lidding materials can comprise layers of paper or wax. Furthermore, the material that provides a source of heat to melt the sealant material (which typically is a metal film, such as a thin aluminum film) can be located in the lower section of the lidding material, or in the upper section of the lidding material, or in both of those sections.

An exemplary lidding material can have an upper region having the features of the present invention and a lower region composed of a laminate comprising a metallic foil layer and a sealant layer. Another exemplary lidding material can have an upper region having the features of the present invention and a thermoplastic film such as PET, an adhesive layer, a layer of paper, an adhesive layer, and a sealant layer. Another exemplary lidding material can have an upper region having the features of the present invention and a lower region composed of a laminate comprising a thermoplastic film such as PET, a barrier coating layer composed of a material such as silicon oxide (SiOx) or polyvinylidene dichloride (PVDC), an adhesive layer, and a sealant layer such as a clear barrier lidding material. Another exemplary lidding material can have an upper region having the features of the present invention and a lower region composed of a laminate comprising a thermoplastic film such as PET, a barrier coating layer, an adhesive layer, a barrier coating layer, a layer of thermoplastic film such as PET, and a sealant layer. Another exemplary lidding material can have an upper region having the features of the present invention and a lower region composed of a laminate comprising a thermoplastic film such as PET, a barrier coating layer, an adhesive layer, a barrier coating layer, a layer of thermoplastic film such as PET, an adhesive layer, and a sealant layer (e.g., ethylene vinylacetate (EVA) or a material commercially available as Surlyn from DuPont); and such a lidding material provides a clear barrier lidding material. Another exemplary lidding material can have an upper region having the features of the present invention and a lower region composed of a laminate comprising a thermoplastic film such as PET, an adhesive layer, a foamed thermoplastic film such as a film having a thickness of about 3 to about 10 mils, an adhesive layer, and a sealant layer. Another exemplary lidding material can have an upper region having the features of the present invention and a lower region composed of a laminate comprising a thermoplastic film such as PET, an adhesive layer, a metallic foil layer, an adhesive layer, and a sealant layer.

An exemplary lidding material can have a lower region having the features of the present invention and an upper region composed of a laminate comprising a thermoplastic film such as PET, an adhesive layer, a foamed thermoplastic film, an adhesive layer, a thermoplastic film, and a synthetic breakaway adhesive layer. Another exemplary lidding material can have a lower region having the features of the present invention and an upper region composed of a laminate comprising a thermoplastic film such as PET, an adhesive layer, a foamed thermoplastic film, a layer of metal foil (e.g., aluminum foil), and a synthetic breakaway adhesive layer. Another exemplary lidding material can have a lower region having the features of the present invention and an upper region composed of a laminate comprising a thermoplastic film such as PET, an adhesive layer, a foamed thermoplastic film, a layer of aluminum foil, an adhesive layer, a thermoplastic film, and a synthetic breakaway adhesive layer.

One exemplary laminated lidding material of the present invention is a laminate having, from top to bottom, an overcoat layer, a thermoplastic film such as PET, an adhesive layer, a foamed thermoplastic film layer, an adhesive layer, a thermoplastic film such as PET, a synthetic breakaway adhesive layer, a thermoplastic film such as PET, a layer of ink, an adhesive layer, a foamed thermoplastic film layer, an adhesive layer, a layer of metallic material such as aluminum foil, an adhesive layer, and a sealant layer.

The present invention also relates to a process for providing sealed containers. The process involves various steps. A main body portion housing contents of the container and having an opening for dispensing those contents is provided. A cap portion for covering the opening of the main body portion is provided. A laminated lidding material of the present invention also is provided, and most preferably that laminated lidding material is provided as a one-component laminate type material. The lidding material is positioned over the opening of the main body portion in such a manner so as to provide for covering of that opening. The lidding material also is positioned so as to fit within the inside of the cap portion. The cap and main body portions are mechanically sealed, and the resulting container assembly is subjected to induction sealing conditions so as to cause sealant of the lidding material to form a seal between the lip of the main body portion and the lidding material.

### BRIEF DESCRIPTION OF THE DRAWINGS

FIG. 1 is a perspective of various components of an unassembled container of the present invention showing a main body portion, a lidding portion and a cap portion; and

FIGS. 2-13 are enlarged, cross-sectional views of certain laminated lidding portions representative of the present invention.

### DETAILED DESCRIPTION OF THE PREFERRED EMBODIMENTS

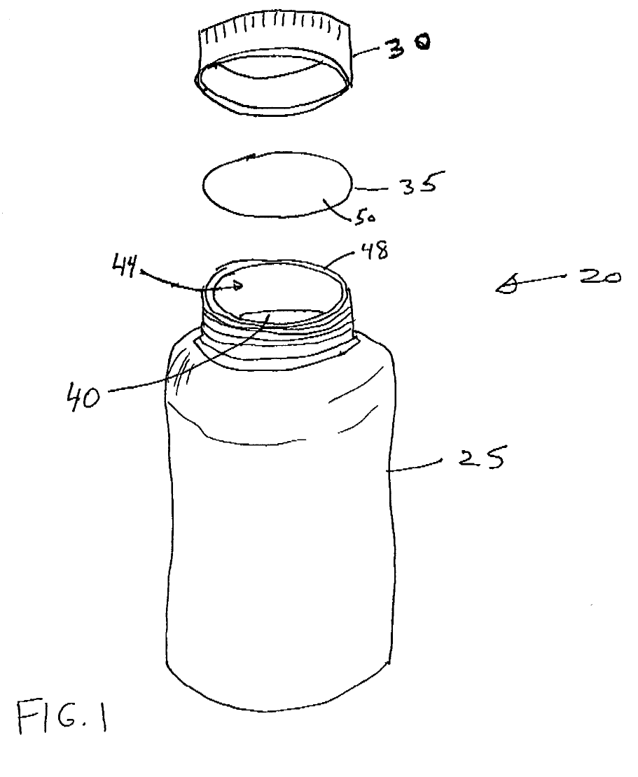

Referring to FIG. 1, there is shown an un-assembled container 20 representative of the present invention, and having the form of a bottle-type assembly. The container 20 comprises a main body portion 25, a cap or closure portion 30, and a lidding portion 35. The lidding portion 35 is designed to fit over the top surface of the of the main body portion 25 and within the inner top region of the cap portion 30. The cap portion 30 and main body portion 25 each are designed so as to fit together to provide an acceptably tight mechanical seal, while being capable of being separated with relative ease under conditions of normal, intended use. Although the embodiment of FIG. 1 depicts a closure mechanism having a screw-on type arrangement, other arrangements, such as pop-off type arrangements, also can be employed.

The main body portion 25 possesses an inner region 40 within which contents (not shown) of the container are housed. The main body portion also possesses an opening 44 at the top region thereof, through which the contents can be loaded or otherwise inserted into the container, as well as dispensed therefrom. The size (e.g., area) and shape of opening is defined by a lip region 48. As shown in FIG. 1, the lip region is designed so as to form an opening having a circular shape.

The lip region 48 of the main body portion is designed so as to provide a bonding surface for the sealant material that is located on the bottom face 50 of the lidding portion. The lip region can have dimensions that can vary. The dimensions of the lip region can depend upon factors such as the size and shape of the main body portion, the material from which that main body portion is manufactured, and the intended use of the container. Usual lip regions have widths of about 1/16 to about ⅜ inch, with widths about 3/32 to about ¼ inch being most typical. Most preferably, the lip region is designed to have a top surface that can be positioned essentially parallel to the inner top face of the cap portion, in order that a portion of the bottom surface of lidding material can contact the top surface of the lid.

The main body portion 25 can be manufactured from a wide variety of materials. Preferably, the main body portion is manufactured from a material or formulation that is suitable for use or has been commonly used as a packaging material or container for foods or pharmaceuticals. Typically, the main body portion is manufactured from glass, HDPE, LDPE, PET, PP, PS, or other suitable material. Mixtures of materials, such as thermoplastic alloys, also can be employed. Preferably, the main body portion is manufactured primarily from thermoplastic materials, and such portions composed primarily of HDPE are particularly preferred. That is, such preferred main body portions that are manufactured from materials such that the majority of the weight of that portion is a thermoplastic material, such as HDPE. Although main body portions can be manufactured from essentially pure thermoplastic material, such as HDPE, the materials used to manufacture such main body portions also can include fillers, pigments, stabilizers, processing aids, and other types of ingredients.

The main body portion is manufactured from a material to which the lidding portion can be applied so as to provide an effective seal, without resulting in significant chemical or physical damage to relevant regions of that main body portion. Main body portions manufactured from plastic materials can be formed in a variety of ways, including injection molding, insert molding, injection blow molding, extrusion blow molding, thermoforming, and compression molding techniques. Although the top surface of the lip region 48 can be chemically or physically treated so as to enhance the ability of the sealant material of the lidding portion, it is most preferred to select materials for the main body portion and to manufacture the main body portion so that such types of treatment are not necessary.

The shape and design of the main body portion can vary. Typically, those features are a matter of choice, and the specific shape or design is not particularly critical. For example, the overall cross-sectional shape of the main body portion is oval, square or round, but usually is generally round (as depicted in FIG. 1). Typically, the opening of the main body portion is oval, square or round, but most preferably is round. Preferably, the size and shape of the main body portion, and the opening thereof, are such that the container can be characterized as a “dispensing container.” Bottles and jars of one piece construction are particularly preferred. The color of the main body portion can vary. Typically, the main body portion is white in color. However, the main body portion can have another color, such as green, blue, yellow, or the like. The main body portion also can be clear and colorless, clear and colored (e.g., brown), or translucent.

The size of the main body portion can vary. Although main body portions of smaller or larger sizes can be used, the main body portion typically is large enough to hold at least about 1 milliliter of product, while the main body portion typically holds up to about 1 liter of product. For many pharmaceutical applications, main body portions capable of containing volumes of about 10 ml to about 250 ml of product are particularly preferred. Although main body portions of smaller or larger sizes can be used, the main body portion typically is large enough to hold at least 25 tablets or capsules of pharmaceutical-type product, while the main body portion typically holds up to about 100 tablets or capsules of such product. For many pharmaceutical-type applications, main body portions capable of containing about 50 to about 150 capsules or tablets of product are particularly preferred.

The type of cap and closure portion 30 can vary. Typical cap portions are screw-on type, child resistant (e.g., tab alignment push and snap type, and push down and turn type), fine ribbed lined closure type, and smooth sided line closure type. Typical cap and closure portions are of one-piece construction, although certain cap and closure portions (particularly for screw-on type caps) can be of multi-piece construction. Typically, the cap portion is manufactured from HDPE, LDPE, PET, PS, PP, or other suitable material. Mixtures of materials, such as thermoplastic alloys, also can be employed. Preferably, the cap portion is manufactured primarily from thermoplastic materials, and such portions composed primarily of LDPE or HDPE are particularly preferred. That is, such preferred cap portions that are manufactured from materials such that the majority of the weight of that portion is a thermoplastic material, such as LDPE or HDPE. Although cap portions can be manufactured from essentially pure thermoplastic material, such as LDPE or HDPE, the materials used to manufacture such main body portions also can include fillers, pigments, stabilizers, processing aids, and other types of ingredients. The color of the cap portion can vary. Typically, the cap portion is white in color. However, the cap portion can have another color, such as orange, red, brown, or the like.

The lidding portion 35 is a laminated material. The lidding portion is designed so as to de-laminate in a controlled, pre-determined manner. Preferably, the lidding portion is provided from a continuous sheet of laminated material, and the shape of the lidding portion is provided by suitable cutting (e.g., die cutting) that lidding portion from the continuous sheet. The lidding portion is designed to fit over the top surface of the main body portion 25 and within the inner top region of the cap portion 30, as is traditionally the case with induction sealed containers. Thus, the specific size and shape of the lidding portion relative to that of the main body portion and the cap portion are matters of choice, and will be readily apparent to one skilled in the art of producing induction sealed containers. Lidding portions of the present invention can be designed so as to be virtually identical in size and shape to those lidding portions that traditionally have been used, hence replacement of the traditional lidding portions with the lidding portions of the present invention can be carried out with relative ease. Preferably, the upper portion of the lidding portion is maintained or secured within the top inner portion of the cap portion, such as by friction fit and/or by, for example, a dab of wax or other suitable adhesive material (not shown); while the lower portion of the lidding material is secured to the upper lip region 48 of the main body portion as a result of the induction sealing process to which the sealed container is subjected.

The main body portion 25, cap or closure portion 30 and lidding material 35 can be assembled using equipment, techniques and conditions that commonly are used to produce container assemblies 20. That is, equipment and methods for preparing, filling and mechanically sealing containers will be apparent to those skilled in the art of container assembly. In addition, the manner of producing sealed container assemblies of the present invention will be readily apparent to one skilled in the art of induction sealed container production. Equipment used to perform induction cap sealing for containers of the present invention has been in commercial use. Representative pieces of equipment are commercially available Pillar, and as the Super Seal series of induction cap sealers from Enercon Industries, Corp.

A resulting sealed container of the present invention possesses a main body portion, a laminated lidding material bonded to the opening of the main body portion, and a sealed cap mechanically sealed to the main body portion to provide closure of the container. When the cap is initially removed during use of the container, the opening of the main body portion possesses a tamper-evident seal provided by the lower portion of the lidding material, and the inner top region of the cap portion possesses a gasket for providing prevention of the passage of environmental contaminants, such as oxygen and moisture, from entering the container when the cap is replaced on the main body portion and properly resealed.

Methods, materials and equipment suitable for manufacturing lidding materials of the present invention are set forth by Weiss in Coating and Laminating Machines, Converting Technology Company (1977); Miller in Converting for Flexible Packaging, (1994); and Rolando in Flexible Packaging—Adhesives, Coatings and Processes (Rapra Review Report 122) (2000). Lamination methods, materials, equipment also are possessed by the RJR Packaging Division of R. J. Reynolds Tobacco Company, Alcan Flexible Packaging, Pechiney, and Alcoa Flexible Packaging.

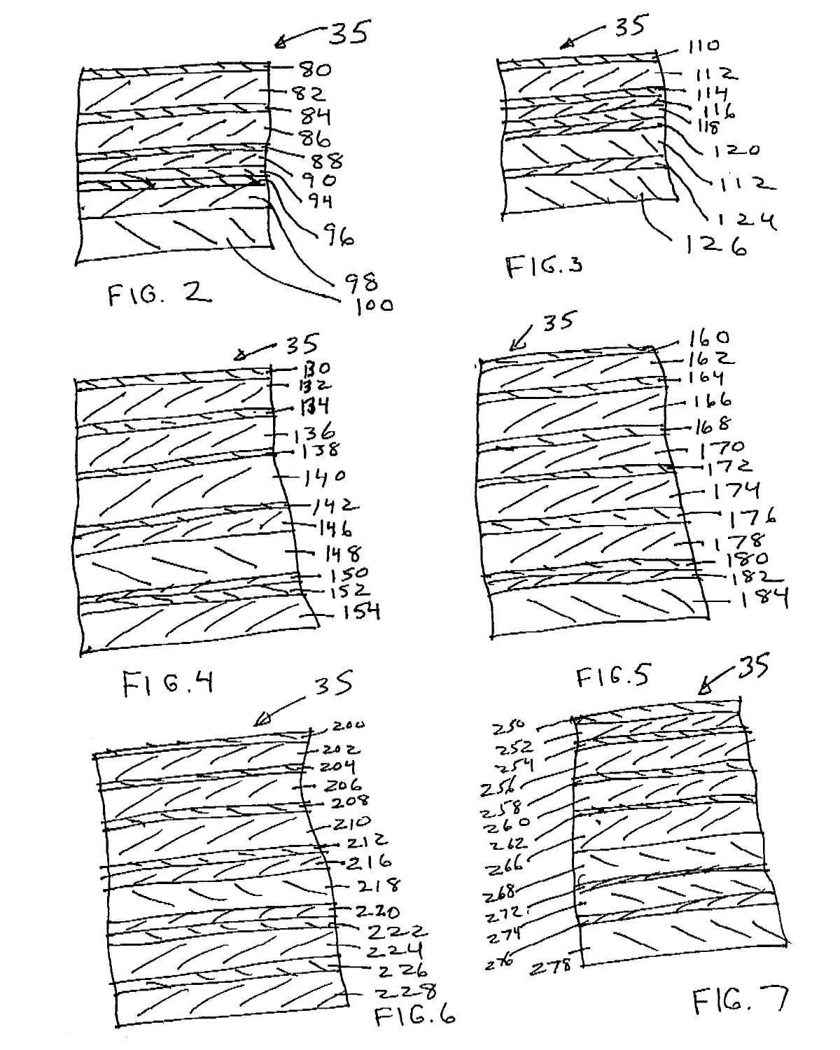

The lamination process is the bonding together of two or more materials to form a multi-ply structure. Most laminations used in the flexible packaging industry require applications of a bonding agent to join various materials together. These agents may be glues, adhesives, hot melts, thermoplastic waxes, or extruded plastics. The five basic types of lamination are wet, dry, thermoplastic, pressure, and extrusion. Laminated lidding materials of the present invention typically have overall thicknesses prior to use of at least about 8 mils, but the overall thicknesses prior to use usually do not exceed about 20 mils. Preferred lidding materials have thicknesses prior to use of about to about 10 to about 15 mils. Laminates representative of the present invention are methods representative of the ways that those laminates are produced are described with reference to FIGS. 2-13. However, it is understood that other laminate configurations can be provided using like materials and manufacturing techniques.

Referring to FIG. 2, there is shown an enlarged, cross-sectional view of a lidding material laminate representative of the present invention. The laminate 35 includes an optional overcoat layer 80, a layer of thermoplastic material 82, an adhesive layer 84, a layer of thermoplastic material 86 which most preferably is a foamed material, an adhesive layer 88, and a layer of thermoplastic material 90. The thermoplastic material of each of layers 82 and 90 most preferably is PET. Layers 80, 82, 84, 86, 88 and 90 ultimately form the so-called “gasket” portion of the lidding assembly, and are intended to remain positioned within the cap portion (not shown) of the container after the container is initially opened. The laminate 35 also further includes a so-called breakaway adhesive layer 94, an optional overcoat layer 96, a layer of metal foil 98, and a layer of sealant material 100. The layer of metal foil 98 most preferably is a layer of aluminum foil, and the sealant material 100 typically is a suitable thermoplastic material. Layers 96, 98 and 100 ultimately form the so-called “tamper-evident” portion of the lidding assembly, and remain positioned on the top lip portion of the main portion (not shown) of the container after the container is initially opened. This laminate defines a lidding material having laminated layers, where certain of the laminated layers are positioned in the following order, from top to bottom: a thermoplastic layer, a gasket layer, a thermoplastic layer, a breakaway adhesive, a metallic foil, and a sealant layer.

The type of lidding material shown in FIG. 2 can be produced by first providing a continuous thermoplastic film (e.g., a PET film) of a desired thickness (e.g., from wound roll using a typical laminator unwind unit and methodologies), applying a solvent-based or water-based overcoating to the outer PET surface, and drying; applying a water-based or solvent-based adhesive formulation to the opposite side of the PET film surface, and drying; and then providing hot lamination of the foamed thermoplastic material to the resulting dried adhesive surface. The resultant lamination is then wound back into roll form. After a specified curing time, the laminated roll is again unwound, a water-based or solvent-based adhesive is applied to the foamed thermoplastic and dried, and the dried adhesive layer is then hot laminated to another PET film. The resultant lamination makes up the upper or gasket portion of the lidding material. In a separate coating process, a continuous sheet of metal foil (e.g., aluminum foil) is unwound and coated with a desirable water-based or solvent-based sealant material and dried, followed by an optional water-based or solvent-based overcoating and drying process. The resultant overcoated foil is then wound back into roll form and now represents the lower or tamper-evident lidding portion of the lidding material. In the final process steps, the laminated upper portion of the lidding material is unwound, a water-based or solvent-based breakaway adhesive material is applied to the PET surface and dried, and the coated foil lidding laminate is then hot laminated to the gasket portion of the lidding material. The resultant lamination is wound into roll form, followed by slitting to desired widths. The slit laminate can be subdivided into lidding material pieces of the desired size and shape. As such, the laminated material is provided by the manufacturer as a so-called “one-component laminate” type of process, and is capable of being used to provide lidding material components of the desired size and shape without the necessity of being subjected to further lamination-type processing steps.

Referring to FIG. 3, there is shown another enlarged, cross-sectional view of a lidding material laminate representative of the present invention. The laminate 35 includes an optional overcoat layer 110, a layer of thermoplastic material 112 which most preferably is a foamed material, and an overcoat layer 114. Layers 110, 112 and 114 ultimately form the gasket portion of the lidding assembly, and are intended to remain positioned within the cap portion (not shown) of the container after the container is initially opened. The laminate 35 also further includes breakaway adhesive layer 116, an optional overcoat layer 118, optional ink 120, a layer of metal foil 122, an adhesive layer 124, and a layer of sealant material 126. Layers 118, 120, 122, 124 and 126 ultimately form the tamper evident portion of the lidding assembly, and remain positioned on the top lip portion of the main portion (not shown) of the container after the container is initially opened. This laminate defines a lidding material having laminated layers, where certain of the laminated layers are positioned in the following order, from top to bottom: a gasket layer, a breakaway adhesive, a metallic foil, and a sealant layer.

The type of lidding material shown in FIG. 3 can be produced by first unwinding a foamed film of a desired thickness, applying an optional solvent-based or water-based overcoat material to the outer foamed film surface and drying; followed by applying a solvent-based or water-based coating to the opposite side of the foamed film surface, and drying. The resultant coated foamed film is then wound back into roll form, now making up the gasket portion of the lidding material. In a separate coating process, the foil is optionally unwound, printed with ink and dried, and then optionally coated and dried with a solvent-based or water-based coating material, and wound back into roll form. The printed foil is then again unwound, a solvent-based or water-based adhesive is applied to the unprinted foil surface and dried, followed by lamination of a mono- or co-extruded sealant film. The resultant material optionally is printed with a suitable ink, and the overcoated foil lamination is then wound back into roll form now represents the lidding portion of the laminated material. In the final process, the gasket material is unwound, a solvent-based or water-based breakaway adhesive material is applied to the overcoated foamed surface and dried, and the optionally coated and printed foil lidding is then hot laminated to the gasket portion. The resultant lamination is wound into roll form, followed by slitting to the desired widths.

Referring to FIG. 4, there is shown another enlarged, cross-sectional view of a lidding material laminate representative of the present invention. The laminate 35 includes an optional overcoat layer 130, a layer of thermoplastic material 132, a layer of adhesive 134, a layer of thermoplastic material 136, which most preferably is a foamed material, a layer of adhesive 138, a layer of metal foil 140, and an overcoat layer 142. Layers 130, 132, 134, 136, 138, 140 and 142 ultimately form the gasket portion of the lidding assembly, and are intended to remain positioned within the cap portion (not shown) of the container after the container is initially opened. The laminate 35 also further includes a breakaway adhesive layer 146, a layer of thermoplastic material 148, optional ink 150, an adhesive layer 152, and a layer of sealant material 154. Layers 148, 150, 152 and 154 ultimately form the tamper evident portion of the lidding assembly, and remain positioned on the top lip portion of the main portion (not shown) of the container after the container is initially opened. This laminate defines a lidding material having laminated layers, where certain of the laminated layers are positioned in the following order, from top to bottom: a thermoplastic layer, a gasket layer, a metallic foil, a breakaway adhesive, a thermoplastic layer, and a sealant layer.

The type of lidding material shown in FIG. 4 can be produced by first unwinding PET film of a desired thickness, applying a solvent-based or water-based overcoating to the outer PET surface and drying, applying a solvent-based or water-based adhesive to the opposite side of the PET film surface and drying, followed by hot lamination of the foamed thermoplastic film to the dried adhesive surface. The resultant lamination is then wound back into roll form. After a specified curing time, this laminated roll is again unwound, a water-based or solvent-based adhesive is applied to the foamed thermoplastic film and dried, and the dried adhesive layer is then hot laminated to a metallic foil of a specified thickness, followed by an application of a solvent-based or water-based overcoat. The resultant lamination is again wound into roll form and now makes up the gasket portion of the laminated lidding material. In a separate laminating process, another PET film, which is already optionally coated with a high barrier material such as (SiOx), PVDC (e.g., Saran which is available from Dow Chemical Co.), ethylenevinylalcohol (EVOH) or polyvinylalcohol (PVOH) is unwound, and optionally printed with ink and dried. The printed surface of the PET film is then coated with a solvent-based or water-based adhesive material and dried, followed by a hot lamination to a mono- or co-extruded sealant film, and winding back into roll form. The resultant optionally printed and coated PET/sealant film now represents the lidding portion of the laminated material. In the final process step, the gasket material is unwound, a solvent-based or water-based breakaway adhesive material is applied to the overcoated foil surface and dried, and the PET/sealant film portion is then hot laminated to the gasket portion. The resultant lamination is wound into roll form, followed by slitting to specified widths.

Referring to FIG. 5, there is shown another enlarged, cross-sectional view of a lidding material laminate representative of the present invention. The laminate 35 includes an optional overcoat layer 160, a layer of thermoplastic material 162, a layer of adhesive 164, a layer of thermoplastic material 166, which most preferably is a foamed material, a layer of adhesive 168, a layer of metal foil 170, a layer of adhesive 172, and a layer of thermoplastic material 174. Layers 160, 162, 164, 166, 168, 170, 172 and 174 ultimately form the gasket portion of the lidding assembly, and are intended to remain positioned within the cap portion (not shown) of the container after the container is initially opened. The laminate 35 also further includes a breakaway adhesive layer 176, a layer of thermoplastic material 178, optional ink 180, an adhesive layer 182, and a layer of sealant material 184. Layers 178, 180, 182 and 184 ultimately form the tamper evident portion of the lidding assembly, and remain positioned on the top lip portion of the main portion (not shown) of the container after the container is initially opened. This laminate defines a lidding material having laminated layers, where certain of the laminated layers are positioned in the following order, from top to bottom: a thermoplastic layer, a gasket layer, a metallic foil, a thermoplastic layer, a breakaway adhesive, a thermoplastic layer, and a sealant layer.

The type of lidding material shown in FIG. 5 can be produced by first unwinding PET film of a desired thickness, applying a solvent-based or water-based overcoating to the outer PET surface and drying, applying a solvent-based or water-based adhesive to the opposite side of the PET film surface and drying, followed by hot lamination of the foamed thermoplastic to the dried adhesive surface. The resultant lamination is then wound back into roll form. After a specified curing time, this laminated roll is again unwound, a water-based or solvent-based adhesive is applied to the foamed thermoplastic and dried, and the dried adhesive layer is then hot laminated to a metallic foil of a specified thickness, followed by another application of a solvent-based or water-based adhesive, drying, and lamination to another PET film. The resultant lamination is again wound into roll form and now makes up the gasket portion of the lidding material. In a separate laminating process, another PET film, which is already optionally coated with a high barrier material, is unwound and optionally printed with ink and dried. The printed surface of the PET is then coated with a solvent or water based adhesive material and dried, followed by a hot lamination to a mono- or co-extruded sealant film and then subsequent winding back into roll form. The resultant optionally printed and coated PET/sealant film now represents the lidding portion of the lidding material. In the final process step, the gasket material is unwound, a solvent-based or water-based breakaway adhesive material is applied to the uncoated PET surface and dried, and the PET/sealant film lidding portion is then hot laminated to the gasket material. The resultant lamination is wound into roll form, followed by slitting to desired widths.

Referring to FIG. 6, there is shown another enlarged, cross-sectional view of a lidding material laminate representative of the present invention. The laminate 35 includes an optional overcoat layer 200, a layer of thermoplastic material 202, a layer of adhesive 204, a layer of thermoplastic material 206, which most preferably is a foamed material, a layer of adhesive 208, a layer of metal foil 210, and an overcoat layer 212. Those layers ultimately form the gasket portion of the lidding assembly, and are intended to remain positioned within the cap portion (not shown) of the container after the container is initially opened. The laminate 35 also further includes a breakaway adhesive layer 216, a layer of thermoplastic material 218, optional ink 220, an adhesive layer 222, a layer of thermoplastic material 224, which most preferably is a foamed material, an adhesive layer 226, and a layer of sealant material 228. Layers 218, 220, 222, 224, 226 and 228 ultimately form the tamper evident portion of the lidding assembly, and remain positioned on the top lip portion of the main portion (not shown) of the container after the container is initially opened. This laminate defines a lidding material having laminated layers, where certain of the laminated layers are positioned in the following order, from top to bottom: a thermoplastic layer, a gasket layer, a metallic foil, a breakaway adhesive, a thermoplastic layer, a foamed thermoplastic layer, and a sealant layer.

The type of lidding material shown in FIG. 6 can be produced by first unwinding PET film of a desired thickness, applying a solvent-based or water-based overcoating to the outer PET surface and drying, applying a solvent-based or water-based adhesive to the opposite side of the PET film surface and drying, followed by hot lamination of the foamed thermoplastic to the dried adhesive surface. The resultant lamination is then wound back into roll form. After a specified curing time, this laminated roll is again unwound, a water-based or solvent-based adhesive is applied to the foamed thermoplastic and dried, and the dried adhesive layer is then hot laminated to a metallic foil of a specified thickness, followed by an application of a solvent-based or water-based overcoat. The resultant lamination is again wound into roll form and now makes up the gasket portion of the lidding material. In a separate laminating process, another PET film, which is already optionally coated with a high barrier material, is unwound and optionally printed with ink and dried. The printed surface of the PET is then coated with a solvent-based or water-based adhesive material and dried, followed by a hot lamination to a foamed film, the subsequent foamed surface having a solvent-based or water-based adhesive applied and dried followed by another hot lamination to a designated mono- or co-extruded sealant film. The resultant lamination is wound back into roll form and now represents the lidding portion of the lidding material. In the final process step, the gasket material is unwound, a solvent-based or water-based breakaway adhesive material is applied to the overcoated foil surface and dried, and the PET/foamed film/sealant film lidding portion is then hot laminated to the gasket material. The resultant lamination is wound into roll form, followed by slitting to desired widths.

Referring to FIG. 7, there is shown another enlarged, cross-sectional view of a lidding material laminate representative of the present invention. The laminate 35 includes an optional overcoat layer 250, a layer of thermoplastic material 252, a layer of adhesive 254, a layer of thermoplastic material 256, which most preferably is a foamed material, a layer of adhesive 258, a layer of metal foil 260, and an overcoat layer 262. Those layers ultimately form the gasket portion of the lidding assembly, and are intended to remain positioned within the cap portion (not shown) of the container after the container is initially opened. The laminate 35 also further includes a breakaway adhesive layer 266, a layer of paper 268, an adhesive layer 272, a layer of thermoplastic material 274, an adhesive layer 276, and a layer of sealant material 278. Layers 268, 272, 274, 276 and 278 ultimately form the tamper evident portion of the lidding assembly, and remain positioned on the top lip portion of the main portion (not shown) of the container after the container is initially opened. This laminate defines a lidding material having laminated layers, where certain of the laminated layers are positioned in the following order, from top to bottom: a thermoplastic layer, a gasket layer, a metallic foil, a breakaway adhesive, a layer of paper, a thermoplastic layer, and a sealant layer.

The type of lidding material shown in FIG. 7 can be produced by first unwinding PET film of a desired thickness (from a typical laminator unwind), applying a solvent-based or water-based overcoating to the outer PET surface and drying, applying a solvent-based or water-based adhesive to the opposite side of the PET film surface and drying, followed by hot lamination of the foamed thermoplastic to the dried adhesive surface. The resultant lamination is then wound back into roll form. After a specified curing time, this laminated roll is again unwound, a water-based or solvent-based adhesive is applied to the foamed thermoplastic and dried, and the dried adhesive layer is then hot laminated to a metallic foil of a specified thickness, followed by an application of a solvent-based or water-based overcoat. The resultant lamination is again wound into roll form and now makes up the gasket portion of the contemplated structure. In a separate laminating process, a PET film is coated with a solvent-based or water-based adhesive and dried, followed by a hot lamination to a mono- or co-extruded sealant film. Solvent-based or water-based adhesive is applied to the opposite side of that lamination, dried, and hot laminated to a paper optionally coated or impregnated with a fluorinated polymer, such as a perfluoropolyther (PFPE) composed of randomly distributed tetrafluoroethyleneoxy and difluoromethyleneoxy units (e.g., such as Fluorolink PFPE which is marketed by Ausimont and FC-807 which is marketed by 3M). The resultant lamination is wound back into roll form and now represents the lidding portion of the lidding material. In the final process step, the gasket material is unwound, overcoated foil has a molten polymer of LDPE or EAA hot laminated to the overcoated surface of the gasket material and the coated paper surface of the lidding material. The resultant lamination is cooled and then wound into roll form, followed by slitting to desired widths.

Referring to FIG. 8, there is shown another enlarged, cross-sectional view of a lidding material laminate representative of the present invention. The laminate 35 includes an optional overcoat layer 350, a layer of thermoplastic material 352, a layer of adhesive 354, a layer of thermoplastic material 356, which most preferably is a foamed material, a layer of adhesive 358, a layer of metal foil 360, and an overcoat layer 362. Those layers ultimately form the gasket portion of the lidding assembly, and are intended to remain positioned within the cap portion (not shown) of the container after the container is initially opened. The laminate 35 also further includes a breakaway adhesive layer 366, a layer of paper 368, an adhesive layer 372, and a layer of sealant material 374. Layers 368, 372, and 374 ultimately form the tamper evident portion of the lidding assembly, and remain positioned on the top lip portion of the main portion (not shown) of the container after the container is initially opened. This laminate defines a lidding material having laminated layers, where certain of the laminated layers are positioned in the following order, from top to bottom: a thermoplastic layer, a gasket layer, a metallic foil, a breakaway adhesive, a layer of paper, and a sealant layer.

The type of lidding material shown in FIG. 8 can be produced by first unwinding PET film of a desired thickness, applying a solvent-based or water-based overcoating to the outer PET surface and drying, applying a solvent-based or water-based adhesive to the opposite side of the PET film surface and drying, followed by hot lamination of the foamed thermoplastic to the dried adhesive surface. The resultant lamination is then wound back into roll form. After a specified curing time, this laminated roll is again unwound, a water-based or solvent-based adhesive is applied to the foamed thermoplastic and dried, and the dried adhesive layer is then hot laminated to a metallic foil of a specified thickness, followed by an application of a solvent-based or water-based overcoat. The resultant lamination is again wound into roll form and now makes up the gasket portion of the lidding material. In a separate laminating process, a paper, which is already optionally coated or impregnated with a fluorinated polymer material, is coated with a solvent-based or water-based adhesive material and dried, followed by a hot lamination to a designated mono- or co-extruded sealant film. The resultant lamination is wound back into roll form and now represents the lidding portion of the lidding material. In the final process step, the gasket material is unwound, the PET surface of the gasket material is coated with a primer and dried (not shown) and a molten polymer of LDPE or ethylene acrylic acid (EAA) is hot laminated to the primed PET surface of the gasket material and the coated paper surface of the lidding material. The resultant lamination is cooled and then wound into roll form, followed by slitting to desired widths.

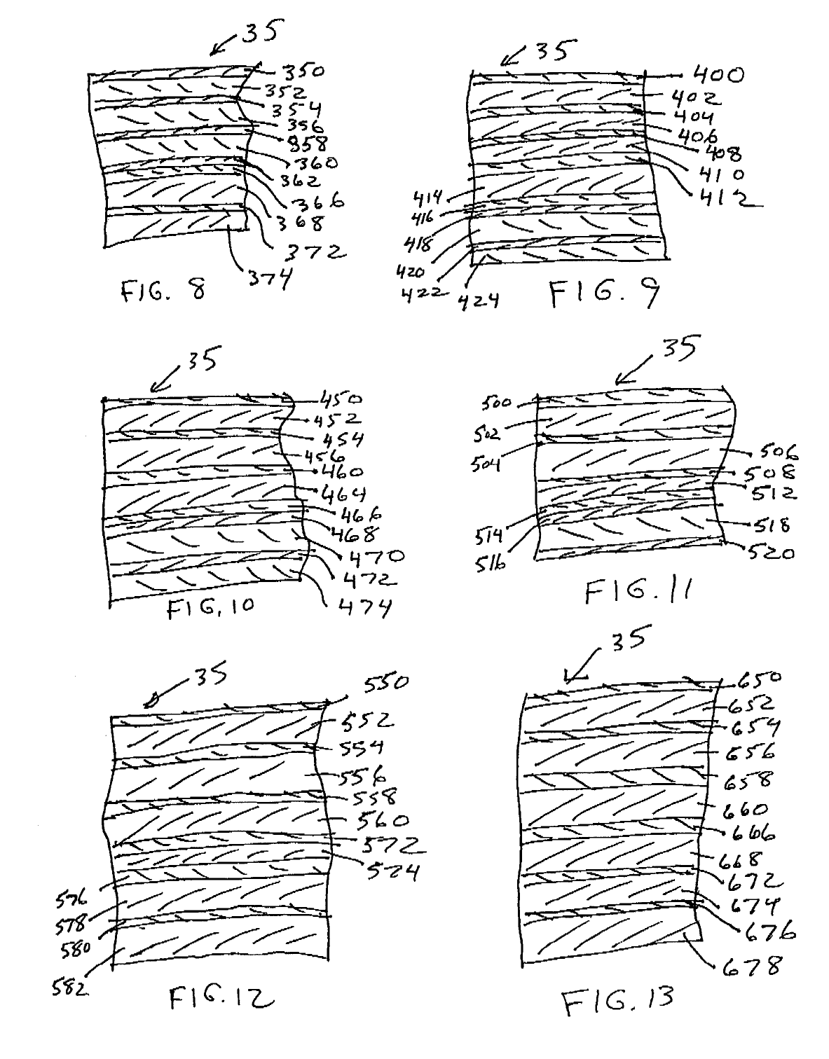

Referring to FIG. 9, there is shown an enlarged, cross-sectional view of a lidding material laminate representative of the present invention. The laminate 35 includes an optional overcoat layer 400, a layer of thermoplastic material 402, an adhesive layer 404, a layer of thermoplastic material 406 which most preferably is a foamed material, an adhesive layer 408, and a layer of thermoplastic material 410. Those layers ultimately form the so-called gasket portion of the lidding assembly, and are intended to remain positioned within the cap portion (not shown) of the container after the container is initially opened. The laminate 35 also further includes a breakaway adhesive layer 412, a layer of thermoplastic material 414, optional ink 416, an adhesive layer 418, a layer of metal foil 420, a layer of adhesive 422, and a layer of sealant material 424. Layers 414, 416, 418, 420, 422 and 424 ultimately form the tamper-evident portion of the lidding assembly, and remain positioned on the top lip portion of the main portion (not shown) of the container after the container is initially opened. This laminate defines a lidding material having laminated layers, where certain of the laminated layers are positioned in the following order, from top to bottom: a thermoplastic layer, a gasket layer, a thermoplastic layer, a breakaway adhesive, a thermoplastic layer, a metallic foil, and a sealant layer.

The type of lidding material shown in FIG. 9 can be produced by first unwinding PET film of a desired thickness, applying a solvent-based or water-based overcoating to the outer PET surface and drying, applying a solvent-based or water-based adhesive to the opposite side of the PET film surface and drying, followed by hot lamination of the foamed thermoplastic to the dried adhesive surface. The resultant lamination is then wound back into roll form. After a specified curing time, the laminated roll is again unwound, a water-based or solvent-based adhesive is applied to the foamed thermoplastic and dried, and the dried adhesive layer is then hot laminated to another PET film. The resultant lamination makes up the gasket portion of the contemplated structure. In a separate process, another PET thermoplastic film is unwound, optionally printed with ink and dried, followed by an application of a solvent-based or water-based adhesive material to the optionally printed PET surface and dried. The dried adhesive surface is then hot laminated to a metallic foil of a desired thickness and then wound back into roll form. This printed PET/foil lamination is then again unwound, a solvent-based or water-based adhesive is applied to the un-laminated foil surface and dried, followed by lamination of a mono- or co-extruded sealant film. The resultant optionally printed and overcoated PET/foil lamination is then wound back into roll form and now represents the lidding portion of the lidding material. In the final process step, the gasket material is unwound, a solvent-based or water-based breakaway adhesive material is applied to the PET surface and dried, and the optionally coated and printed PET/foil lidding is then hot laminated to the gasket material. The resultant lamination is wound into roll form, followed by slitting to desired widths.

Referring to FIG. 10, there is shown an enlarged, cross-sectional view of a lidding material laminate representative of the present invention. The laminate 35 includes an optional overcoat layer 450, a layer of thermoplastic material 452, an adhesive layer 454, a layer of thermoplastic material 456 (which most preferably is a porous material having the form of a woven, non-woven or spun bound polymeric material), and a layer of a wax-type material 460. Those layers ultimately form the so-called gasket portion of the lidding assembly, and are intended to remain positioned within the cap portion (not shown) of the container after the container is initially opened. The laminate 35 also further includes a layer of thermoplastic material 464, optional ink 466, an adhesive layer 468, a layer of metal foil 470, a layer of adhesive 472, and a layer of sealant material 474. Layers 464, 466, 468, 470, 472 and 474 ultimately form the tamper-evident portion of the lidding assembly, and remain positioned on the top lip portion of the main portion (not shown) of the container after the container is initially opened. This laminate defines a lidding material having laminated layers, where certain of the laminated layers are positioned in the following order, from top to bottom: a thermoplastic layer, a gasket layer composed of a porous thermoplastic material, a breakaway adhesive in the form of wax, a thermoplastic layer, a metallic foil, and a sealant layer.

The type of lidding material shown in FIG. 10 can be produced by first unwinding PET film of a desired thickness, applying a solvent-based or water-based overcoating to the outer PET surface and drying, applying a solvent-based or water-based adhesive to the opposite side of the PET film surface and drying, followed by hot lamination of the woven, non-woven, or spun bound thermoplastic to the dried adhesive surface. The resultant lamination is then wound back into roll form and now makes up the gasket portion of the contemplated structure. In a separate process, another PET thermoplastic film is unwound, optionally printed with ink and dried, followed by an application of a solvent-based or water-based adhesive material to the optionally printed PET surface and dried. The dried adhesive surface is then hot laminated to metallic foil of a desired thickness and then wound back into roll form. This printed PET/foil lamination is then again unwound, a solvent-based or water-based adhesive is applied to the un-laminated foil surface and dried, followed by lamination of a mono- or co-extruded sealant film. The resultant optionally printed and overcoated PET/foil lamination is then wound back into roll form and now represents the lidding portion of the lidding material. In the final process step, the gasket material is unwound, a hot wax is applied to the porous material and then laminated to the PET surface of the lidding material. The resultant lamination is wound into roll form, followed by slitting to desired widths. The hot wax lamination alternatively can be accomplished at a separate facility that is used to produce a conventional-type two-component lidding material using a hot wax lamination process. The wax used for preparing such a lidding material can be the type of wax that has been used to provide conventional lidding materials. Such materials have been used commercially for producing laminates of the type that are the subject of the present invention. Thus, virtually any such material can be employed in virtually the same manner that is traditional, and as such, the selection, formulation, use and specifications will be apparent to one skilled in the art of designing and manufacturing laminates for use as lidding materials for induction sealing containers.

Referring to FIG. 11, there is shown an enlarged, cross-sectional view of a lidding material laminate representative of the present invention. The laminate 35 includes an optional overcoat layer 500, a layer of thermoplastic material 502, an adhesive layer 504, a layer of thermoplastic material 506 which most preferably is a foamed material, and an overcoat layer 508. Those layers ultimately form the so-called gasket portion of the lidding assembly, and are intended to remain positioned within the cap portion (not shown) of the container after the container is initially opened. The laminate 35 also further includes a breakaway adhesive layer 512, an optional overcoat layer 514, optional ink 516, a layer of metal foil 518, and a layer of sealant material 520. Layers 514, 516, 518 and 520 ultimately form the tamper-evident portion of the lidding assembly, and remain positioned on the top lip portion of the main portion (not shown) of the container after the container is initially opened. This laminate defines a lidding material having laminated layers, where certain of the laminated layers are positioned in the following order, from top to bottom: a thermoplastic layer, a gasket layer, a breakaway adhesive, a a metallic foil, and a sealant layer.

The type of lidding material shown in FIG. 11 can be produced by first unwinding PET film of a desired thickness, applying a solvent-based or water-based overcoating to the outer PET surface and drying, applying a solvent-based or water-based adhesive to the opposite side of the PET film surface and drying, followed by hot lamination of the foamed thermoplastic to the dried adhesive surface. The resultant lamination is then wound back into roll form. In a separate coating process, the metallic foil is unwound, and optionally printed with ink and dried, followed by coating with a desirable solvent-based or water-based sealant material and dried, followed by an optional solvent-based or water-based overcoating and drying process. The resultant overcoated foil is then wound back into roll form and now represents the lidding portion of the lidding material. The first lamination is now unwound and a solvent-based or water-based coating is applied to the thermoplastic foamed surface and dried, followed by a solvent-based or water-based breakaway adhesive material being applied to the overcoat surface and dried. The previously coated foil lidding is now hot laminated to the breakaway adhesive layer. The resultant lamination is wound into roll form, followed by slitting to desired widths.

Referring to FIG. 12, there is shown an enlarged, cross-sectional view of a lidding material laminate representative of the present invention. The laminate 35 includes an optional overcoat layer 550, a layer of thermoplastic material 552, an adhesive layer 554, a layer of thermoplastic material 556 which most preferably is a foamed material, an adhesive layer 558, and a thermoplastic layer 560. Those layers ultimately form the so-called gasket portion of the lidding assembly, and are intended to remain positioned within the cap portion (not shown) of the container after the container is initially opened. The laminate 35 also further includes a breakaway adhesive layer 572, an optional overcoat layer 574, optional ink 576, a layer of metal foil 578, an adhesive layer 580, and a layer of sealant material 582. Layers 574, 576, 578, 580 and 582 ultimately form the tamper-evident portion of the lidding assembly, and remain positioned on the top lip portion of the main portion (not shown) of the container after the container is initially opened. This laminate defines a lidding material having laminated layers, where certain of the laminated layers are positioned in the following order, from top to bottom: a thermoplastic layer, a gasket layer, a thermoplastic layer, a breakaway adhesive, a metallic foil, and a sealant layer.

The type of lidding material shown in FIG. 12 can be produced by first unwinding PET film of a desired thickness, applying a solvent-based or water-based overcoating to the outer PET surface and drying, applying a solvent-based or water-based adhesive to the opposite side of the PET film surface and drying, followed by hot lamination of the foamed thermoplastic to the dried adhesive surface. The resultant lamination is then wound back into roll form. After a specified curing time, the laminated roll is again unwound, a water-based or solvent-based adhesive is applied to the foamed thermoplastic and dried, and the dried adhesive layer is then hot laminated to another PET film. The resultant lamination makes up the gasket portion of the contemplated structure. In a separate coating process, the metallic foil is optionally unwound, printed with ink and dried, and then optionally coated and dried with a solvent-based or water-based coating material and wound back into roll form. The printed foil is then again unwound, a solvent-based or water-based adhesive is applied to the unprinted foil surface and dried, followed by lamination of a mono- or co-extruded sealant film. The resultant optionally printed and overcoated foil lamination is then wound back into roll form and now represents the lidding portion of the lidding material. In the final process step, the gasket material is unwound, a solvent-based or water-based breakaway adhesive material is applied to the PET surface and dried, and the optionally coated and printed foil lidding is then hot laminated to the gasket material. The resultant lamination is wound into roll form, followed by slitting to predetermined widths.

Referring to FIG. 13, there is shown another enlarged, cross-sectional view of a lidding material laminate representative of the present invention. The laminate 35 includes an optional overcoat layer 650, a layer of thermoplastic material 652, a layer of adhesive 654, a layer of thermoplastic material 656, which most preferably is a foamed material, a layer of adhesive 658, and a layer of thermoplastic material 660. Those layers ultimately form the gasket portion of the lidding assembly, and are intended to remain positioned within the cap portion (not shown) of the container after the container is initially opened. The laminate 35 also further includes a breakaway adhesive layer 666, a layer of paper 668, an adhesive layer 672, a layer of metallic foil 674, an adhesive layer 676, and a layer of sealant material 678. Layers 668, 672, 674, 676 and 678 ultimately form the tamper-evident portion of the lidding assembly, and remain positioned on the top lip portion of the main portion (not shown) of the container after the container is initially opened. This laminate defines a lidding material having laminated layers, where certain of the laminated layers are positioned in the following order, from top to bottom: a thermoplastic layer, a gasket layer, a thermoplastic layer, a breakaway adhesive, a layer of paper, a metallic foil, and a sealant layer.

The lidding material shown in FIG. 13 can be produced by first unwinding PET film of a desired thickness, applying a solvent-based or water-based overcoating to the outer PET surface and drying, applying a solvent-based or water-based adhesive to the opposite side of the PET film surface and drying, followed by hot lamination of the foamed thermoplastic to the dried adhesive surface. The resultant lamination is then wound back into roll form. After a specified curing time, this laminated roll is again unwound, a water-based or solvent-based adhesive is applied to the foamed thermoplastic and dried, and the dried adhesive layer is then hot laminated to a PET film of a specified thickness. The resultant lamination is again wound into roll form and now makes up the gasket portion of the lidding structure. In a separate laminating process, a metallic foil is coated with a solvent-based or water-based adhesive and dried, followed by a hot lamination to a mono- or co-extruded sealant film. Solvent-based or water-based adhesive is applied to the opposite side of that lamination, dried, and hot laminated to a paper optionally coated or impregnated with a fluorinated polymer, such as a perfluoropolyther (PFPE) composed of randomly distributed tetrafluoroethyleneoxy and difluoromethyleneoxy units (e.g., such as Fluorolink PFPE which is marketed by Ausimont and FC-807 which is marketed by 3M). The resultant lamination is wound back into roll form and now represents the lidding portion of the lidding material. In the final process step, the gasket material is unwound, the PET surface of the gasket material is coated with a primer and dried (not shown) and a molten polymer of LDPE or EAA is hot laminated to the primed PET surface of the gasket material and the coated paper surface of the lidding material. The resultant lamination is cooled and then wound into roll form, followed by slitting to predetermined widths.

The laminated lidding material may possess a layer of overcoat material. Overcoat layers of laminated lidding materials of the present invention can be optional in certain circumstances, but it is preferred that those overcoat layers are employed when constructing laminates of the present invention. The overcoat material can vary. Various overcoat materials have been used commercially for coating materials of the type that are the subject of the present invention. Thus, virtually any overcoat material or formulation can be employed in virtually the same manner that is traditional, and as such, the selection, formulation, use and specifications will be apparent to one skilled in the art of designing and manufacturing laminates for use as lidding materials for induction sealing containers. An overcoat is a covering or finish applied to a substrate to protect or enhance the properties of that substrate. Examples of substrates that can be overcoated include thermoplastic films (e.g., PET films), metal foil (e.g., aluminum foil), or paper. Overcoats are chosen for their ability to adhere to the substrate and the desired properties of the finished surface (e.g., gloss, abrasion resistance, chemical resistance, control of coefficient of friction), and the like. The overcoat typically is applied to a substrate in a fluid form, and then the overcoat is set to achieve the desired functional properties. The transition from fluid to solid may be accomplished by the cooling or drying of a thermoplastic, the release of a solvent or carrier, or a chemical reaction such as cross-linking. The selection of the specific overcoat also depends upon factors such as the equipment used to carry out the application of the lidding material to the container, the desired sealing and opening properties of the container, and other like factors. Typical overcoat materials are either water-based or solvent-based suspensions containing nitrocellulose, acrylate-type polymers such as polymethylmethacrylate (PMMA), PS, and the like. Representative overcoats that are commercially available are heat resistant water based acrylic lacquers, such as 1339A Pharmaceutical Lacquer available from Coatings and Adhesives Corporation. Overcoats can be applied to substrates using a variety of techniques, such as offset, rotogravure or flexographic coating techniques. Typically, an overcoat forms a layer on or within the laminated lidding material that ranges in thickness from about 0.01 to about 0.25 mil. See, Martens, Technology of Paints, Varnishes, and Lacquers (1968) and Weiss, Coating and Laminating Machines (1977).

Preferred laminated lidding structures contain at least one layer of thermoplastic material, such as a thermoplastic film. Oriented polymeric films (e.g., oriented PET films) are preferred. Those oriented film provide good mechanical properties, such as temperature stability, lay flat properties, chemical resistance and printability, as compared to unoriented films, foamed oriented films or foamed unoriented films. Although oriented PET is preferred, although other oriented film materials, such as oriented polypropylene (OPP), oriented polyamide (OPA), and oriented polyethylene (OPE), can be used. See, for example, U.S. Pat. No. 5,342,684 to Carespodi, which is incorporated herein by reference, for a description of a suitable thermoplastic films and film components. Where improved barrier properties or foil like appearance are required it is also possible to use a metalized film, such as a metallized oriented film. A preferred metallized film is a metallized polyethylene terephthalate (MPET). See, for example, U.S. Pat. No. 5,427,235 to Powell et al., which is incorporated herein by reference, for a description of a suitable thermoplastic films, film components, and metalized oriented films. Various thermoplastic materials have been used commercially for providing barrier layers for lidding materials of the type that are the subject of the present invention. Thus, virtually any film material or formulation can be employed in virtually the same manner that is traditional, and as such, the selection, formulation, use and specifications will be apparent to one skilled in the art of designing and manufacturing laminates for use as lidding materials for induction sealing containers. Typical thermoplastic material layers have thicknesses of about 0.25 to about 2, often about 0.5 to about 1.5 mils. Certain representative oriented thermoplastic films are biaxially oriented PET films of 0.36 mil, 0.48 mil and 0.92 mil thickness. Such types of films can be applied to either or both sides of a foamed thermoplastic (e.g., foamed LDPE, foamed PP or foamed HDPE) layer that has a thickness of about 3 to about 15, usually about 4 to about 12 mils, using a two component urethane adhesive formulation. A representative commercially available two component polyurethane type adhesive is available as Tycel from the Liofol Company. See also, for example, U.S. Pat. No. 5,342,684 to Carespodi, for a description of representative adhesive components and formulations. To offer chemical resistance to the contents of the container, oriented thermoplastic film (e.g., PET films) also can be laminated, using suitable adhesives, between the sealant layer of the laminate and the rest of the laminate.

The laminated lidding material employs adhesive to secure various layers of the laminate together. As such, typical laminates possess at least one layer of adhesive. The adhesive material can vary. Various adhesive materials have been used commercially for producing laminates of the type that are the subject of the present invention. Thus, virtually any adhesive material or formulation can be employed in virtually the same manner that is traditional, and as such, the selection, formulation, use and specifications will be apparent to one skilled in the art of designing and manufacturing laminates for use as lidding materials for induction sealing containers. Adhesives preferably are those that can bond together two materials by surface attachment. Examples of substrate materials that can be bonded together by adhesive lamination include thermoplastic polymers, aluminum foil, sealant films, and paper sheets. Adhesives are chosen so that the adhesion between an adhesive material and the substrate it is applied to is greater that the cohesion within the adhesive material. Upon application, adhesives bond together two components of the lidding material in such a way that the components remained bonded together during the application of the lidding material to the surface material of the main body portion of the container and during the removal of the lidding material from the container. Preferably, the adhesive is applied to a substrate in a fluid form, and then the adhesive is allowed to set to achieve a desirably high cohesive strength. The transition from fluid to solid may be accomplished by the heating of a thermoplastic, the release of a solvent or carrier, a chemical reaction such as cross-linking, or other suitable mechanism. The selection of the specific adhesive depends upon factors such as the various components of the lidding material that are to be bonded together, the equipment used to carry out the application of the lidding material to the container, the desired sealing and opening properties, and other like factors. Typical adhesive materials are either thermoplastic or thermoset materials, and can include components such as PE, PP, and the like. Representative adhesives that are commercially available are two component polyurethane type adhesives such as Tycel from the Liofol Company. See, for example, U.S. Pat. No. 5,342,684 to Carespodi, for a description of suitable adhesive components and formulations. Adhesives can be applied to the lidding components using a variety of techniques, such as thermal lamination. Typically, adhesives form layers on the laminated lidding materials that are at least about 0.1 mil thick; but adhesive layers usually have thicknesses of less than about 0.5, and often less than about 0.25 mil. Adhesives can be modified to enhance the lidding material functionality. An example of such a modification involves use of a removable type adhesive that remains permanently tacky in its solvent-free form. Such a removable adhesive can be used to allow separation of the layers of the lidding material to form a flap to aid in removing the lidding material from the container.

The laminated lidding material incorporates a material that acts as a gasket. Such a component preferably is provided by a synthetic material, such as a thermoplastic material. Thermoplastic materials provide replacement of the cellulosic paperboard materials traditionally used to form gasket materials for induction sealed container assemblies. The gasket can be produced from a foamed or cavitated material, and is designed to remain in the container cap portion. Thus, the gasket serves as an inexpensive filler layer for the cap portion of the container. Typical gasket layers have thicknesses of greater than about 7, and usually of at least about 8 mil; while those typical layers usually have thicknesses of up to about 15 mil.; depending on the type of cap portion, closure mechanism, and other components of the lidding structure. Preferred layers have thicknesses of about 9 to about 12 mil. Preferred gasket layer materials are somewhat compressible. After the container is opened and the sealed portion is removed the gasket that remains in the cap portion preferably provides sufficient seal integrity as to prevent leakage of the product from the re-sealed container, or to prevent the passage of oxygen and moisture into the re-sealed container. Exemplary materials include foamed LDPE, foamed HDPE, and foamed PP. Representative foamed polyolefins are supplied by Fuji America and Performance Packaging for the induction seal lidding market. Certain useful gasket materials are referred to as “white PE films.” See, also, U.S. Pat. No. 5,342,684 to Carespodi, which is incorporated herein by reference, for examples of suitable types of materials useful as gasket layer components. Preferably, the foamed layer is a foamed polyolefin or cavitated material that does not collapse during the capping and sealing process, but does perform the gasket function as desired. Foamed polyolefin gaskets can be encased in layers of other thermoplastic films, such as oriented thermoplastic films or other suitable materials, in order to improve the heat stability of those foamed materials. Various foamed or cavitated materials have been used commercially for producing laminates of the type that are the subject of the present invention. Thus, virtually any foamed or cavitated polyolefin material or formulation can be employed in virtually the same manner that is traditional, and as such, the selection, formulation, use and specifications will be apparent to one skilled in the art of designing and manufacturing laminated materials.

The gasket portion of the laminated lidding materials also can be provided by a porous, absorbent layer can be composed of any thermoplastic material which can be formed into a web by fabric forming technologies. Common technologies include, but are not limited to, thermal bonding, spun bonding, melt blowing, resin bonding, or air laid technologies. Typical thermoplastic materials include PET, PE, PP, PVA, or nylon. The porous materials used to provide certain laminated materials of the present invention can vary. Exemplary materials are spun bonded olefins such as Tyvek Type 1059B from DuPont, spun bonded nylon such as Cerex PBN-11 Fabric from James River Corp., spun bonded polypropylene such as Veraspun from Veratec (Canada) Inc., and non woven polyester such as Dura-Tex Polyester from Scott Nonwovens. Other suitable porous materials are available from Eastman Chemical and Kimberly-Clark Corp. The porous nature of the material is related to regions of air within that material and the ability of that material to absorb, become impregnated, or otherwise contain an adjacent material, such as heated molten wax. The porous layer is bonded to gasket layer using conventional bonding technologies used in the flexible packaging industry (e.g., adhesive or extrusion lamination). The porous layer faces downward, and functions as a wick to absorb adhesive material (e.g., the wax coating) during the induction sealing process. When the cap portion is initially removed from the container during use, the sealed lidding portion of the laminate remains adhered to the container lip, and the gasket breaks free (i.e., debonds from the lower lidding portion of the lidding material), thus remaining within the cap portion. The gasket portion remains within the cap, and functions as a seal for future use during re-sealing of the container. The basis weight of the porous layer typically ranges from about 0.3 to about 5 ounces per square yard. Such porous materials typically have thicknesses of about 2 to about 10, often about 3 to about 6 mils. It is most preferred that the porous materials are laminated to another material, such as a thermoplastic (e.g., PET) film.

The material that provides heat to the sealant can vary. Preferably, that material is a material that possesses very high thermal conductivity. Various such materials have been used commercially for producing laminates of the type that are the subject of the present invention. Thus, virtually any such material can be employed in virtually the same manner that is traditional, and as such, the selection, formulation, use and specifications will be apparent to one skilled in the art of designing and manufacturing laminates for use as lidding materials for induction sealing containers. Typically, that material is a metallic material, or a material composed primarily of metallic material. The metallic material can be an essentially pure metal or an alloy. Exemplary metallic materials are composed of aluminum, or aluminum of acceptable commercial purity. For example, the material can be a thin layer of aluminum, such as an aluminum foil. Preferred metallic materials are composed primarily of aluminum (i.e., the majority of the weight of the material is aluminum). An exemplary material is available commercially as 1100 aluminum alloy. Exemplary aluminum foil used in the present invention is most typically continuous cast aluminum foil that is rolled to gauge. Continuous cast aluminum foil is produced by melting aluminum ingot, such as alloy aluminum 1100, casting the molten aluminum onto cooled chilled rollers, and then cold rolling the aluminum foil to the desired thickness, usually about 0.7 to about 3, preferably about 1 to about 2 mils. Direct cast aluminum foil also can be employed. Direct cast foil is produced by pouring molten aluminum into an ingot, pre-heating and/or homogenizing the ingot, and then hot rolling the aluminum into a desired intermediate thickness. The resulting rolled material then is cold rolled to the desired thickness. Aluminum alloys that are typically used in the direct cast process contain aluminum of greater than 99 weight percent purity. Aluminum foils useful for providing the foil layers for laminates of the present invention are available from the RJR Packaging Division of R. J. Reynolds Tobacco Company and from Alcoa. Preferred metallic foil layers can provide a physical barrier as well as a barrier to the passage of atmospheric components, such as oxygen and moisture.

The laminated lidding material possesses a layer of sealant material. Sealant materials preferably are those that can form a layer of a laminated material. Sealant materials also are materials that melt at temperatures lower that the melting temperatures of other components of the container assembly. Upon melting, preferred sealant materials maintain adherence to the rest of the lidding material, but also form adherence to the surface material of the main body portion of the container. As such, after being exposed to heat and being melted, and after being again exposed to essentially ambient conditions, the sealant material hardens. Hardening of the sealant material provides bonding, and hence a seal, between the lip region of the main body portion of the container and the remaining components of the lidding material. The selection of the specific sealant material depends upon factors such as the lidding material to which the sealant material is laminated, the composition and properties of the surface of the lip region to which the sealant is expected to bond, the equipment used to carry out the induction sealing process, the desired sealing and opening properties, and other like factors.

The sealant material can vary. Various sealant materials have been used commercially for producing laminates of the type that are the subject of the present invention. Thus, virtually any sealant material or formulation can be employed in virtually the same manner that is traditional, and as such, the selection, formulation, use and specifications will be apparent to one skilled in the art of designing and manufacturing laminates for use as lidding materials for induction sealing containers. Typical sealant materials are thermoplastic materials, in many cases are polyolefin materials, and can include components such as PP, LDPE, EAA, EVA, metallacene linear low density polyethylene (mLLDPE), linear low density polyethylene (LLDPE), ethylene methacrylic acid (EMAA), certain polypropylene copolymers (PPE), and the like. Suitable EAA, LLDPE, LDPE and mLLDPE are available from the Dow Chemical Company; and suitable LDPE is available from Chevron. For example, the sealant material can have the form of a single layer of LDPE, a single layer of EVA, a single layer of EAA, a single layer of LLDPE, a single layer of a metallacene-type material commercially available as Affinity from the Dow Chemical Co., or Exact from Exxon, a single layer of EMAA, a single layer of a metal neutralized EMAA commercially available as Surlyn from DuPont, or any number of sealant materials that are considered useful within the flexible packaging industry. Sealant materials can be coated, mono-extruded or co-extruded. See, for example, U.S. Pat. No. 4,784,885 to Carespodi, which is incorporated herein by reference, for representative materials and techniques for providing and using suitable sealant materials. These sealant materials can be altered, depending upon the lidding material, to make them “peelable.” Typical materials that are used to accomplish this task include polybutylene (PB), talc, and other materials as generally understood as standard art in the flexible packaging industry. Alternatively, the sealant material can be composed of a co-extruded or laminated film that contains those sealant materials described previously, aluminum foil, or a multiple layer combination of polymers (e.g., a co-extruded film) designed to provide stiffness, sealability, resistance to moisture and water barrier transgression and/or peelability. A representative blend of materials is a mixture of EVA and PB. Most preferably, sealant materials form layers on bottom surfaces of the laminated lidding materials; and those layers usually range in thickness from about 0.25 to about 4 mils, frequently from about 0.5 to about 4 mils. See, Djordjevic in Coextrusion (Rapra Review Report 62) (1992).

The preferred lidding materials are so-called “one-component laminate type” laminates. That is, the laminated lidding materials can be produced by the supplier of that lidding material laminate. Thus, the user of the lidding material does not need to laminate two laminated materials together, for example, by using wax coating techniques. The laminated lidding materials most preferably are designed so as to incorporate a layer of synthetic breakaway adhesive. Such an adhesive most preferably incorporates a thermoplastic adhesive material or formulation comprising EVA, EAA, or the like. Such an adhesive can be made from a pressure sensitive adhesive (PSA), or from water-based or solvent-based heat seal coatings containing EVA or other suitable thermoplastic materials. Such an adhesive separates from the adjacent layer of thermoplastic film material when subjected to the application of heat during the induction sealing process step. That is, certain adhesives, such as certain types of EVA and certain types of EAA, provide a so-called “tack lamination” to the adjacent thermoplastic film, only to separate from that film upon further heating (e.g., at temperatures above about 200° F.). Preferred breakaway adhesives dry to a material having a relatively low density, stick relatively poorly to substrates, and have adhesive characters that are reduced or eliminated upon exposure to an effective amount of heat. A representative material useful for providing a breakaway adhesive is a water-based heat seal dispersion available as Adcote 37P295 from Rohm and Haas. A representative adhesive formulation conaining EVA, or other suitable adhesive material, can be coated onto another component of the lidding material using techniques such as gravure printing, so as to provide a final coat weight after drying of about 0.5 to about 3 pounds of coating per ream (i.e., 3000 square feet). Usually, adequate adhesive properties are exhibited using full coverage coating of adhesive in an amount of less than about 1 pound of coating per ream.

The breakaway adhesive feature of the present invention can be accomplished by applying a small amount of the designated EVA or EAA coating to a thermoplastic film surface (e.g., a PET surface). The coverage can be either full or patterned. For example, a full film provided continuous coverage can be used, or the film can be discontinuous and patterned in the form of stripes, checks, dots, grids, honeycombs, or the like. Then, the coated thermoplastic film surface is supplied with a minimal amount of heat to the designated tamper evident lidding component of the structure. The adhesive does not adhere well to the thermoplastic film surface on further heating, resulting in a breakaway of the coated thermoplastic film surface from the remainder of the lidding material. It is also possible to accomplish the breakaway feature when using full or patterned PSA coverage on the thermoplastic film surface. Preferably, the PSA provides enough “tack” to hold the entire lidding structure intact during die cutting, but not enough tack to prevent the separation of the laminate as intended upon opening of the container by the consumer. Typical PSA coating provide final coat weight after drying of about 0.2 to about 2 pounds of coating per ream, with adequate adhesive properties being exhibited using coverage coating of that adhesive in an amount of about 1 pound of coating per ream.

A PSA is a modified adhesive that are viscoelastic material which in solvent-free form remain permanently tacky and will adhere instantaneously to most solid surfaces with the application of very slight pressure. Pressure-sensitive adhesive may be used to join the lidding material that is to remain sealed to the container and the gasket material that is to remain within the removable cap. This adhesive would then allow the two distinct layers to be easily separated when the cap is removed from the container. Representative PSA and the uses thereof are set forth in Satas (Ed.), Handbook of Pressure Sensitive Adhesive Technology, 3^{rd} Ed. (1999), and Benedek, Pressure-Sensitive Formulation (2000). Also useful are the types of PSA set for in Skeist, Handbook of Adhesives, 2^{nd} Ed., pp. 726-734 (1977), and particularly, the types of pressure sensitive acrylate adhesives set forth at p. 728. Representative PSA are available as CraigStik 3994 RJR, and as those other 3994 series adhesives from Craig Adhesives & Coatings Co.

The thickness of the breakaway adhesive layer can vary. Usually, the thickness of the breakaway adhesive layer does not exceed 1 mil, and often does not exceed 0.8 mil. Typically, the thickness of the breakaway adhesive layer 0.05 to about 0.5 mil.

The paper materials used in providing certain laminated materials of the present invention can vary. Preferred papers are so-called “grease proof” papers. Representative papers are available from Wausau Mosinee Paper Corporation as 41# Rhi-Pel 153 (grade 331-9475) 3.2 mil, and from Curtis Papers Inc. as 41# CIS Styaynless (grade 790/410/10) 3.0 mil. Typically, paper materials thicknesses of at least about 1, often about 1.5 mil; while typical papers have thicknesses of less than 5, often less than 3.5 mils.

Any of the materials of the present invention can be appropriately primed using a variety of known primers. Various primers have been used commercially for producing laminates of the type that are the subject of the present invention. Thus, virtually any primer material or formulation can be employed in virtually the same manner that is traditional, and as such, the selection, formulation, use and specifications will be apparent to one skilled in the art of designing and manufacturing laminates for use as lidding materials for induction sealing containers. Exemplary primers are available from Mica, Inc. For example, a suitable primer can be used to promote adhesion of the breakaway adhesive layer to a layer of thermoplastic (e.g., PET) film.

The lidding materials and systems of the present invention present several advantages over those types of lidding materials and systems that traditionally have been employed. Traditional thermoplastic bottle-type containers for pharmaceutical products have employed a two-component laminate type lidding system that incorporates a laminate of foil and plastic film of tamper evident lidding material that separates from a wax coated paperboard gasket material. The wax coated paperboard gasket material that remains within the cap portion when initially opened by the consumer is not particularly hygienic and can be subject to contamination. That is, particularly when the contents of the container are a liquefied drug emulsion or suspension, that liquid can come into contact with the paperboard gasket material. For example, the wax layer of coating the paperboard gasket can be damaged, or the re-sealed container can be stored upside down. As such, liquid contents of the container have the potential to come into contact with the cellulosic materials that comprise the gasket. Preferred gasket materials of the present invention are manufactured from synthetic thermoplastic materials, rather than from natural cellulosic fiber materials. Highly preferred lidding materials are manufactured virtually entirely of synthetic thermoplastic materials and processed metallic materials. The synthetic materials possess much less potential to cause any contamination of the contents of the container.

The laminated lidding material of the present invention preferably undergoes some chemical separation in the desired manner upon induction sealing. Preferred lidding materials possess synthetic layers that are broken upon initial separation of the cap portions from the main body portions of those containers. As such, the one-component laminate type of process of the present invention provides a tamper-evident seal to the opening of the main body portion, and a gasket virtually composed completely of synthetic material remains within the inner top region of the cap portion to act as a gasket. Furthermore, the one-component laminate type of design of the lidding materials of the present invention results in time savings, reductions in production costs, and elimination of process steps. That is, the traditional step of wax laminating two laminates together to form a lidding material is not necessary when the laminate of the present invention is employed.

What is claimed is:

1. A laminated lidding material comprising a thermoplastic gasket layer, a breakaway adhesive layer, a layer of metal foil, and a layer of sealant.

2. The material of claim 1 wherein the laminate is absent of a layer of wax.

3. The material of claim 1 wherein the laminate is absent of a layer of paperboard material.

4. The material of claim 3 wherein the laminate is absent of a layer of wax.

5. The material of claim 1 wherein the gasket layer has a thickness of about 8 to about 20 mils.

6. The material of claim 1 wherein the layer of metal foil is composed primarily of aluminum and possesses a thickness of about 1 to about 2 mils.

7. The material of claim 1 further including at least one further layer of thermoplastic material.

8. The material of claim 7 wherein the further layer of thermoplastic material is composed of polyethylene terephalate.

9. The material of claim 1 wherein the gasket layer is not composed of a paperboard material.

10. The material of claim 1 further comprising a layer of paper.

11. The material of claim 1 wherein the breakaway adhesive layer is composed of a pressure sensitive adhesive.

12. The material of claim 1 wherein the breakaway adhesive layer is composed of ethylene vinyl acetate.

13. The material of claim 1 wherein the breakaway adhesive layer is composed of ethylene acrylic acid.

14. The material of claim 1 wherein the breakaway adhesive layer has a thickness of less than about 1 mil.

15. The material of claim 1 wherein the gasket layer comprises a thermoplastic material.

16. The material of claim 1 wherein the gasket layer comprises a foamed thermoplastic material.

17. The material of claim 1 wherein the gasket layer comprises a non-woven thermoplastic material.

18. The material of claim 1 comprising laminated layers, wherein certain of the laminated layers are positioned in the following order, from top to bottom: a thermoplastic layer, a gasket layer, a thermoplastic layer, a breakaway adhesive, a metallic foil, and a sealant layer.

19. The material of claim 1 comprising laminated layers, wherein certain of the laminated layers are positioned in the following order, from top to bottom: a gasket layer, a breakaway adhesive, a metallic foil, and a sealant layer.

20. The material of claim 1 comprising laminated layers, wherein certain of the laminated layers are positioned in the following order, from top to bottom: a a thermoplastic layer, gasket layer, a metallic foil, a breakaway adhesive, a thermoplastic layer, and a sealant layer.

21. The material of claim 1 comprising laminated layers, wherein certain of the laminated layers are positioned in the following order, from top to bottom: a thermoplastic layer, gasket layer, a metallic foil, a thermoplastic layer, a breakaway adhesive, a thermoplastic layer, and a sealant layer

22. The material of claim 1 comprising laminated layers, wherein certain of the laminated layers are positioned in the following order, from top to bottom: a thermoplastic layer, gasket layer, a metallic foil, a breakaway adhesive, a thermoplastic layer, a foamed thermoplastic layer, and a sealant layer.

23. The material of claim 1 comprising laminated layers, wherein certain of the laminated layers are positioned in the following order, from top to bottom: a thermoplastic layer, gasket layer, a metallic foil, a breakaway adhesive, a layer of paper, a thermoplastic layer, and a sealant layer.

24. The material of claim 1 comprising laminated layers, wherein certain of the laminated layers are positioned in the following order, from top to bottom: a thermoplastic layer, gasket layer, a metallic foil, a breakaway adhesive, a layer of paper, and a sealant layer.

25. The material of claim 1 comprising laminated layers, wherein certain of the laminated layers are positioned in the following order, from top to bottom: a thermoplastic layer, gasket layer, a thermoplastic layer, a breakaway adhesive, a thermoplastic layer, a metallic foil, and a sealant layer.

26. The material of claim 1 comprising laminated layers, wherein certain of the laminated layers are positioned in the following order, from top to bottom: a thermoplastic layer, a gasket layer composed of a porous thermoplastic material, a breakaway adhesive in the form of wax, a thermoplastic layer, a metallic foil, and a sealant layer.

27. The material of claim 1 comprising laminated layers, wherein certain of the laminated layers are positioned in the following order, from top to bottom: a thermoplastic layer, gasket layer, a breakaway adhesive, a thermoplastic layer, a metallic foil, and a sealant layer.

28. The material of claim 1 comprising laminated layers, wherein certain of the laminated layers are positioned in the following order, from top to bottom: a thermoplastic layer, gasket layer, a thermoplastic layer, a breakaway adhesive, a layer of paper, a metallic foil, and a sealant layer.

29. A container comprising:
a) a main body portion including a region to house contents and an opening to dispense contents from that main body portion;
b) a cap portion; and
c) a lidding portion; the lidding portion having the form of a laminate possessing a thermoplastic gasket layer, a breakaway adhesive layer, a layer of metal foil, and a layer of sealant.

30. The container of claim 29 wherein the main body portion is composed primarily of high density polyethylene.

31. The container of claim 29 wherein the cap portion is composed primarily of low density polyethylene.

32. The container of claim 29 wherein the thermoplastic gasket layer is secured within the cap portion.

33. The container of claim 29 wherein the laminate is absent of wax.

34. The container of claim 29 wherein the laminate is absent of a layer of paperboard material.

35. The container of claim 34 wherein the laminate is absent of wax.

36. The material of claim 1 wherein the gasket layer has a thickness of about 8 to about 20 mils.

37. The container of claim 29 wherein the layer of metal foil is composed primarily of aluminum and possesses a thickness of about 1 to about 2 mils.

38. The container of claim 29 wherein the laminate further includes at least one further layer of thermoplastic material.

39. The container of claim 38 wherein the further layer of thermoplastic material is composed of polyethylene terephalate.

40. The container of claim 29 wherein the gasket layer of the lidding material is not composed of a paperboard material.

41. The container of claim 40 wherein the laminate further comprises a layer of paper.

42. The container of claim 29 wherein the breakaway adhesive layer of the lidding material is composed of a pressure sensitive adhesive.

43. The container of claim 29 wherein the breakaway adhesive layer of the lidding material is composed of ethylene vinyl acetate.

44. The container of claim 29 wherein the breakaway adhesive layer of the lidding material is composed of ethylene acrylic acid.

45. The container of claim 29 wherein the breakaway adhesive layer of the lidding material has a thickness of less than about 1 mil.

46. The container of claim 29 wherein the gasket layer of the lidding material comprises a thermoplastic material.

47. The container of claim 29 wherein the gasket layer of the lidding material comprises a foamed thermoplastic material.

48. The container of claim 29 wherein the gasket layer of the lidding material comprises a non-woven thermoplastic material.

49. The container of claim 29 having a lidding material comprising laminated layers, wherein certain of the laminated layers are positioned in the following order, from top to bottom: a thermoplastic layer, a gasket layer, a thermoplastic layer, a breakaway adhesive, a metallic foil, and a sealant layer.

50. The container of claim 29 having a lidding material comprising laminated layers, wherein certain of the laminated layers are positioned in the following order, from top to bottom: a gasket layer, a breakaway adhesive, a metallic foil, and a sealant layer.

51. The container of claim 29 having a lidding material comprising laminated layers, wherein certain of the laminated layers are positioned in the following order, from top to bottom: a a thermoplastic layer, gasket layer, a metallic foil, a breakaway adhesive, a thermoplastic layer, and a sealant layer.

52. The container of claim 29 having a lidding material comprising laminated layers, wherein certain of the laminated layers are positioned in the following order, from top to bottom: a thermoplastic layer, gasket layer, a metallic foil, a thermoplastic layer, a breakaway adhesive, a thermoplastic layer, and a sealant layer

53. The container of claim 29 having a lidding material comprising laminated layers, wherein certain of the laminated layers are positioned in the following order, from top to bottom: a thermoplastic layer, gasket layer, a metallic foil, a breakaway adhesive, a thermoplastic layer, a foamed thermoplastic layer, and a sealant layer.

54. The container of claim 29 having a lidding material comprising laminated layers, wherein certain of the laminated layers are positioned in the following order, from top to bottom: a thermoplastic layer, gasket layer, a metallic foil, a breakaway adhesive, a layer of paper, a thermoplastic layer, and a sealant layer.

55. The container of claim 29 having a lidding material comprising laminated layers, wherein certain of the laminated layers are positioned in the following order, from top to bottom: a thermoplastic layer, gasket layer, a metallic foil, a breakaway adhesive, a layer of paper, and a sealant layer.

56. The container of claim 29 having a lidding material comprising laminated layers, wherein certain of the laminated layers are positioned in the following order, from top to bottom: a thermoplastic layer, gasket layer, a thermoplastic layer, a breakaway adhesive, a thermoplastic layer, a metallic foil, and a sealant layer.

57. The container of claim 29 having a lidding material comprising laminated layers, wherein certain of the laminated layers are positioned in the following order, from top to bottom: a thermoplastic layer, a gasket layer composed of a porous thermoplastic material, a breakaway adhesive in the form of wax, a thermoplastic layer, a metallic foil, and a sealant layer.

58. The container of claim 29 having a lidding material comprising laminated layers, wherein certain of the laminated layers are positioned in the following order, from top to bottom: a thermoplastic layer, gasket layer, a breakaway adhesive, a thermoplastic layer, a metallic foil, and a sealant layer.

59. The container of claim 29 having a lidding material comprising laminated layers, wherein certain of the laminated layers are positioned in the following order, from top to bottom: a thermoplastic layer, gasket layer, a thermoplastic layer, a breakaway adhesive, a layer of paper, a metallic foil, and a sealant layer.

60. The container of claim 19 having a laminated lidding material comprising laminated layers, wherein the layers are positioned in the following order, from top to bottom: an overcoat layer, a thermoplastic layer, an adhesive layer, a gasket layer in the form of a foamed thermoplastic film, an adhesive layer, a thermoplastic film layer, a breakaway adhesive layer, a thermoplastic film layer, a layer of ink, an adhesive layer, a foamed thermoplastic film layer, an adhesive layer, a layer of metallic material, an adhesive layer, and a sealant layer.

61. The container of claim 29 wherein the gasket layer is composed of a porous thermoplastic material.

62. The container of claim 61 wherein the gasket layer has a thickness of about 2 to about 10 mils.

63. The container of claim 29 in sealed form as a result of induction sealing.
